(19) United States
(12) Patent Application Publication
(10) Pub. No.: US 2003/0070007 A1
(43) Pub. Date: Apr. 10, 2003

(54) System and method for IP tunneling through an OSI network

(76) Inventor: Raffi Tchakmakjian, Montreal (CA)

Correspondence Address: Paul E. Franz, Esq., JONES, DAY, REAVIS & POGUE, North Point, 901 Lakeside Avenue, Cleveland, OH, 44114, US

(21) Appl. No.: 10/267,478

(22) Filed: Oct. 9, 2002

Related U.S. Application Data
(60) Provisional application No. 60/328,190, filed on Oct. 9, 2001.

(51) Int. Cl. G06F 15/16

(52) U.S. Cl. 709/330

(57) ABSTRACT

A system (10) for providing Internet Protocol (IP) tunneling over an Open System Interconnect (OSI) network system having a plurality of network elements includes a topology module (110) executable on a first network element (20) and operable to determine a first network element topology of network elements eligible for IP tunneling for the first network element (20), a mapping module (120) executable on the first network element (20) and operable to map the network elements eligible for IP tunneling to corresponding IP addresses, and an encapsulation/decapsulation module (130) executable on the first network element (20) and operable to encapsulate an IP datagram into an OSI frame and decapsulate the IP datagram from an OSI frame.

This application claims benefit of U.S. Provisional Patent Application Ser. No. 60/328,190, file Oct. 9, 2001 and entitled “Mechanisms For IP Tunneling Through An OSI Network,” the entire disclosure of which is incorporated herein by reference.

### BACKGROUND

1. Field of the Invention

The present invention relates generally to the field of data communication networks. More specifically, a mechanism for IP tunneling through an Open System Interconnect (OSI) network is provided that is particularly well suited for use in a Synchronous Optical Network (SONET) system.

2. Description of the Related Art

Transmission Control Protocol/Internet Protocol (TCP/IP) is a common protocol for Data Communication Networks (DCNs) and has become a de facto standard. Another common DCN is the Synchronous Optical Network (SONET), which is based on the Open System Interconnect (OSI) reference model and uses OSI protocols. A SONET system comprises a high-bandwidth ring of network elements interconnected by fiber optic data lines. Usually, one or more IP networks are connected to the SONET ring through the network elements. One of the channels the network elements communicate over is a Data Communication Channel (DCC) in the SONET system. Telcordia (Bellcore) specifies OSI as the mandatory communications protocol for the SONET DCC layer.

IP and OSI protocols, however, do not readily interoperate. Thus, IP traffic between IP networks that are not directly connected to each other is “tunneled” through the SONET network. In normal IP tunneling, IP traffic between IP networks not directly connected to each other is transmitted in the payload portion of a Synchronous Payload Envelop (SPE) over the SONET system.

The SPEs transmitted over the SONET system comprise the payload section and a Transport Overhead (TOH) section. Included in the TOH is the DCC that is used for Operations, Administration, Maintenance and Provisioning (OAM&P) on the SONET system. OAM&P may be conducted from a computer connected to an IP network which, in turn, is connected to the SONET system. However, as previously mentioned the IP and OSI protocols do not readily interoperate. Furthermore, only a small bandwidth channel is usually required for OAM&P, and thus it is not efficient to use the entire bandwidth of the SONET channel for OAM&P.

### SUMMARY

A method of providing IP tunneling over an OSI network system comprising a plurality of network elements comprises the steps of determining a first network element topology of network elements eligible for IP tunneling for a first network element, mapping the network elements eligible for IP tunneling to corresponding IP address, and encapsulating an IP datagram into an OSI frame, transmitting the IP datagram over the OSI network, and decapsulating the IP datagram from the OSI frame.

A system for providing IP tunneling over an OSI network system comprising a plurality of network elements comprises a topology module, a mapping module, and an encapsulation/decapsulation module. The topology module is executable on a first network element and operable to determine a first network element topology of network elements eligible for IP tunneling for the first network element. The mapping module is executable on the first network element and operable to map the network elements eligible for IP tunneling to corresponding IP addresses. The encapsulation/decapsulation module is executable on the first network element and operable to encapsulate an IP datagram into an OSI frame and decapsulate the IP datagram from an OSI frame.

Another system for providing IP tunneling over an OSI network system comprising a plurality of network elements comprises means for determining a first network element topology of network elements eligible for IP tunneling for a first network element, means for mapping the network elements eligible for IP tunneling to corresponding IP address, and means for encapsulating an IP datagram into an OSI frame and decapsulating the IP datagram from the OSI frame.

### BRIEF DESCRIPTION OF THE DRAWINGS

FIG. 1 is a block diagram of a system for providing IP tunneling over an OSI network;

FIG. 2 is a block diagram of an IP tunneling module implemented on Connectionless Network Protocol (CLNP) in the network layer;

FIG. 3 is a flow diagram illustrating a process of IP tunneling over an OSI network;

FIG. 4 is a block diagram of an OSI network comprising a plurality of network elements, a subset of which provides IP tunneling over the OSI network;

FIG. 5 is a diagram of a Network Service Access Point (NSAP) address including a selector octect;

FIG. 6 is a block diagram of an illustrative OSI network, an associated Intermediate System-to-Intermediate System (IS-IS) table, and four iterations of a topology table;

FIG. 7 is a flow diagram illustrating a process of network discovery;

FIG. 8 is a flow diagram illustrating a process of address resolution; and

FIG. 9 is a flow diagram illustrating a process of managing a pseudo-Address Resolution Protocol (pseudo-ARP) request.

### DETAILED DESCRIPTION

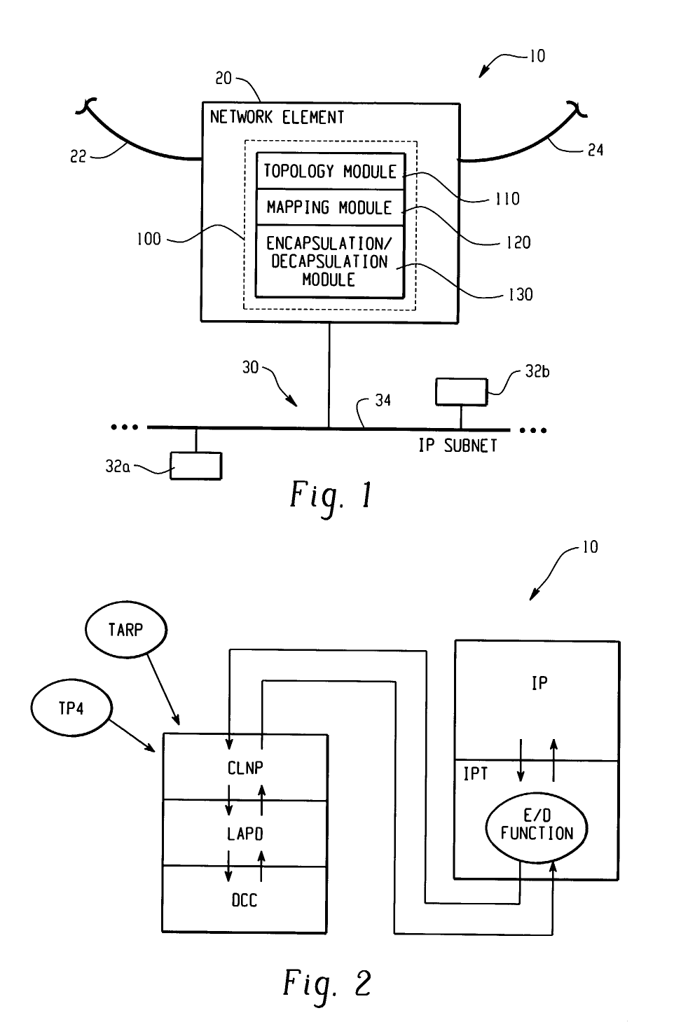

FIG. 1 is a block diagram of a system 10 for providing IP tunneling over an OSI network. The portion of the OSI network shown comprises a network element 20 connected to data lines 22 and 24. In one embodiment, the OSI network is a SONET system, wherein the network element 20 is a Marconi MCN-7000 Advance Multiple Services Carrier Node from Marconi Communications, and data lines 22 and 24 are fiber optic communication lines in a SONET ring. Other OSI based networks may also be used.

Connected to the network element 20 is an IP subnet 30 that utilizes an IP protocol. The portion of the IP subnet 30 shown comprises a plurality of computer devices 32a and 32b interconnected by a data line 34. In one embodiment, the IP subnet 30 is an Ethernet network.

Stored in the network element 20 is an IP tunneling module 100. The IP tunneling module 100 is illustratively a software program comprising a topology module 110, a mapping module 120, and an encapsulation/decapsulation module 130. In one embodiment, the topology module 110 comprises a ring topology discovery algorithm, the mapping module 120 comprises a MAC/NSAP address resolution protocol, and the encapsulation/decapsulation module 130 encapsulates/decapsulates IP datagrams into/from OSI datagrams.

IP connectivity from computers 32a, 32b on the IP subnet 30 to the network elements in the SONET network is provided through the SONET DCC channel. The SONET DCC channel runs an OSI stack. The IP tunneling module 100 allows the use of the IP protocol over the DCC channel through the OSI stack, which facilitates management tasks from IP-based clients.

The IP tunneling module 100 enables management of the network element 20, IP devices attached to the network element 20, and other network elements having similar IP tunneling modules 100. Thus, a Network Management System (NMS) can send and receive IP information (useful for SNMP events and traps, for example) to any network element 20 having IP tunneling modules 100 in an OSI area.

By utilizing the IP tunneling module 100 in the network elements 20, network operators do not need OSI equipment/software in their networks, such as the IP subnet 30, and thus network management systems can be strictly IP-based, if desired. Additionally, the IP tunneling module 100 allows the use of features such as FTP and TFTP through the SONET ring, and thus network operators are not restricted to FTAM, which is the OSI version of FTP. Also, the IP tunneling module 100 allows the use of features such as SNMP and DHCP/bootp through the SONET ring. In one embodiment, in which the network element 20 is a Marconi MCN-7000, the IP tunneling module 100 is compatible with the RIP routing protocol, versions 1, 2 and 2 multicast, which are implemented in the MCN-7000.

FIG. 2 is a block diagram of the IP tunneling module 100 implemented on Connectionless Network Protocol (CLNP) in the network layer. The IP tunneling module 100 is abstracted as a data link layer driver for IP and a layer above CLNP for OSI. It interacts with the IP network layer protocol in the TCP/IP stack and the CLNP layer in OSI.

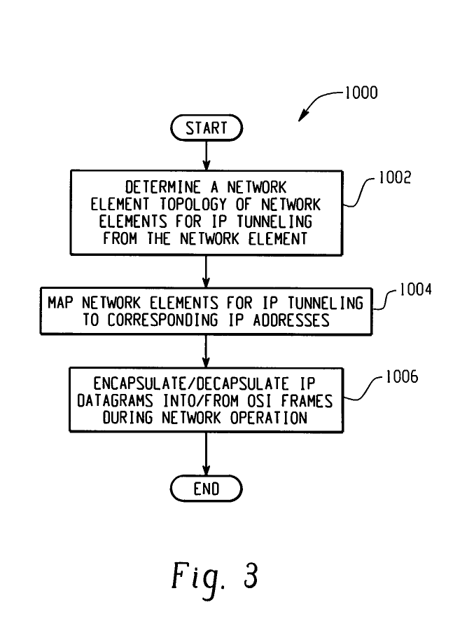

FIG. 3 provides a flow diagram 1000 illustrating a process of IP tunneling over an OSI network. In step 1002, the topology module 110 of the network element 20 determines a network element topology of network elements eligible for IP tunneling from the network element 20. The network element topology is stored as the addresses of all the network elements eligible for IP tunneling in a topology table. Thereafter, in step 1004, the mapping module 120 of the network element 20 maps the addresses of the network elements stored in the topology table to IP addresses. Finally, in step 1006, the encapsulation/decapsulation module 130 encapsulates/decapsulates IP datagrams into/from OSI frames during network operation.

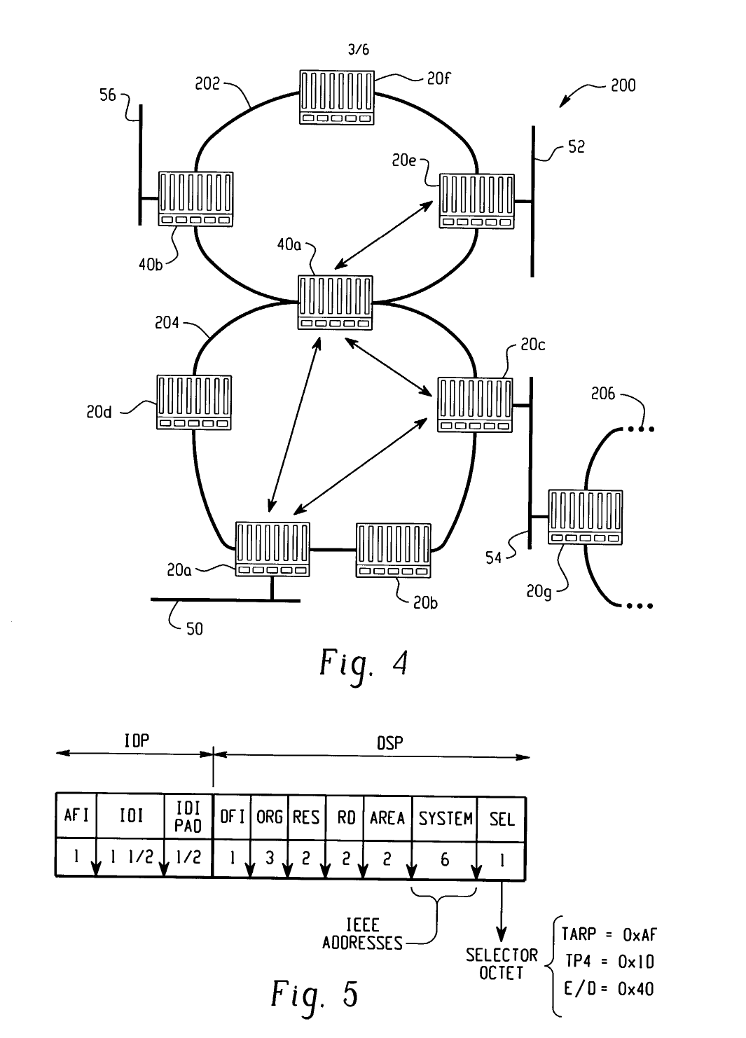

FIG. 4 is a block diagram of an OSI/IP network 200. The OSI/IP network 200 comprises network elements 20a-20g, each having an IP tunneling module 100, and network elements 40a and 40b, which do not have an IP tunneling module 100. IP subnets 50, 52, 54 and 56 are connected to network elements 20a, 20e, 20c and 40b, respectively. The OSI/IP network 200 comprises three rings 202, 204 and 206. Rings 202 and 204 are in direct communication over an OSI channel, i.e., are connected directly by the same data link format. Ring 206 is connected to rings 202 and 204 by the IP subnet 54, which is intermediate data link format that is not common to the data link format of rings 202 and 204. The IP subnet 54 can also be another type of LAN, such as an IPX LAN or an OSI LAN.

The IP tunneling module 100 sends and receives IP datagrams using OSI based channels. The IP datagram is formed down to the network layer, encapsulated in an OSI packet and sent through the DCC channel to the destination. At the destination, the IP datagram is de-capsulated from the OSI packet and sent to the destination IP address.

For the OSI/IP network 200, the IP tunneling module 100 limits IP tunneling over the OSI channel to network elements 20a-20f. A network element 20 can communicate via IP tunneling with any other network element 20 as long as they are in the same OSI area and not separated by an intermediate data link format, i.e., and there is no IP subnet, such as a LAN, separating them. For example, network elements 20a, 20c and 20e, or computers on the IP subnets 50, 52 and 54 can communicate with each other via IP tunneling, but network element 20g cannot communicate with the network elements 20a, 20c and 20e via IP tunneling, as the network element 20g is separated by an intermediate data link format, i.e., IP subnet 54.

Additionally, IP tunneling is available through network element 40a, even though network element 40g does not have an IP tunneling module 100. Because the IP datagram is encapsulated in the OSI frame, the OSI frame is passed through the network element 40g. Thus, a computer connected to IP subnet 50 can facilitate OAM&P for the network elements 20a-20f. Furthermore, OSI equipment and/or software is not needed on the IP subnet 50, and thus the network management system connected to the IP subnet 50 can be strictly IP-based, if desired.

The purpose of limiting tunneling to network elements 20 not separated by an intermediate data link format is to limit the number of network elements 20 eligible for tunneling. In an alternative embodiment, if both network elements 20 separated by a LAN are IP routers, tunneling is provided.

In yet another embodiment, IP tunneling is possible between network elements separated by an intermediate data link format. In this embodiment, another algorithm or method of limiting the number of network elements 20 is implemented, e.g., network elements are limited by a maximum number, or by a manufacturer type, etc. Other limiting algorithms may also be used. OSI data containing the tunneled IP data is then “tunneled” over the IP subnet to other network elements 20 implementing the tunneling module 100. For example, if the OSI/IP network comprises a SONET network coupled to Ethernet IP subnets, IP datagrams tunneled from network element 20a to network element 20g is “tunneled” over the Ethernet IP subnet, as the IP datagrams are data transmitted in the OSI frames.

In one embodiment, the tunneling route is considered as one IP hop, and each network element 20 is not considered an IP hop. Thus, a tracert command will portray a more realistic view of the IP network by hiding the internal OSI nodes at the network elements 20.

The IP tunneling module 100 comprises the topology module 110, the mapping module 120, and the encapsulation/decapsulation module 130. How the network elements are found, how the destination OSI node address is found according to the IP/MAC address, and how IP datagrams are transformed into OSI frames are handled by the topology module 110, the mapping module 120, and the encapsulation/decapsulation module 130, respectively.

Encapsulation/decapsulation comprises taking an IP datagram and inserting/removing it into/from an OSI frame. The IP datagram is inserted into the DCC channel bytes D1-D3 of the TOH of an SPE. The DCC channel is a 192 kbps channel for message-based administration, alarm, and other communication needs over OSI. The IP data transferred in the DCC may correspond to the whole IP datagram, or to a segment of an IP datagram. The illustrative embodiment utilizes only the D1-D3 bytes in the section overhead of an SPE; however, in another embodiment, IP tunneling may also be realized by utilizing bytes D4-D9 in the line overhead of the SPE.

In the illustrative embodiment, the encapsulation/decapsulation of IP-OSI occurs as a service above the CLNP level network layer. The IP frame is encapsulated into one or more CLNP frames at a first network element 20 and the IP frame is extracted from the CLNP frames at another network element having an IP tunneling module 100. Thus, the IP frame is handled as data for transmission in the CLNP frames.

Existing segmentation mechanisms in the IP layer are utilized by dynamically specifying that the maximum frame size that the underlying layer IP tunneling module 100 can process is that of the of the maximum frame size of the DCC LAPD (Link Access Procedure channel D). The IP tunneling module 100 utilizes a selector octet in the NSAP address for the encapsulation/decapsulation. The maximum frame size is configurable and it is set in the L2 info field in the OSI stack, which currently has a range between 512 and 4096 bytes. Other frame sizes may be utilized, depending on system limitations and specifications.

The IP encapsulation/decapsulation module 130 is implemented as a service on top of CLNP, similar to a service implementation such as TARP or TP4, as shown in FIG. 2. The selector octet of the NSAP address is therefore assigned a specific value, as shown in FIG. 5. In one embodiment, the value is compatible to the other services already defined and in conformance with Telcordia /Bellcore specifications and ISO/IEC requirements. In this illustrative embodiment, currently assigned selectors are TARP=0xAF, TP4=0x1D. The IP encapsulation/decapsulation module 130 service selector is provisionable, and has a default value of 0x40.

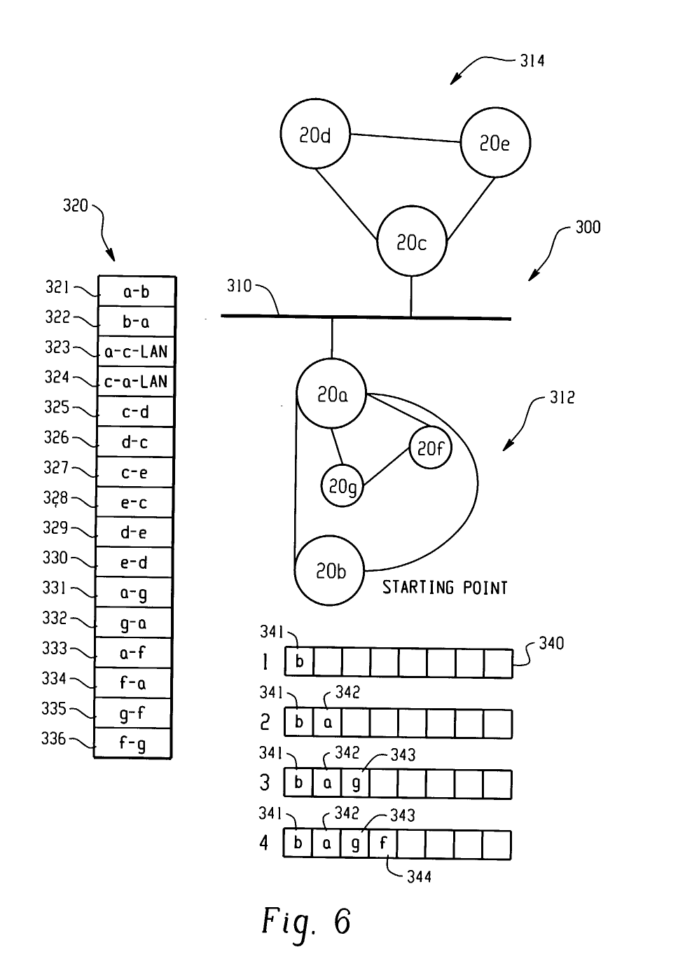

FIG. 6 is a block diagram of another illustrative OSI network 300, an associated Intermediate System-to-Intermediate System (IS-IS) table 320, and four iterations of a topology table 340. The OSI network comprises network elements 20a-20f, and an IP subnet 310. Network elements 20a, 20b, 20f and 20g form a first common data link network 312, and network elements 20c, 20d and 20e form a second common data link network 314.

The topology discovery is driven by broadcast traffic. The topology module 110 creates a topology table 340 that is populated by addresses the network elements 20 in the same OSI area and not separated by an intermediate data link format, e.g. none of the network elements are separated by a LAN of type IP or OSI. The IS-IS Level 1 Link State Database, which contains all level 1 links for the OSI area, is used to extract data into the IS-IS table 320.

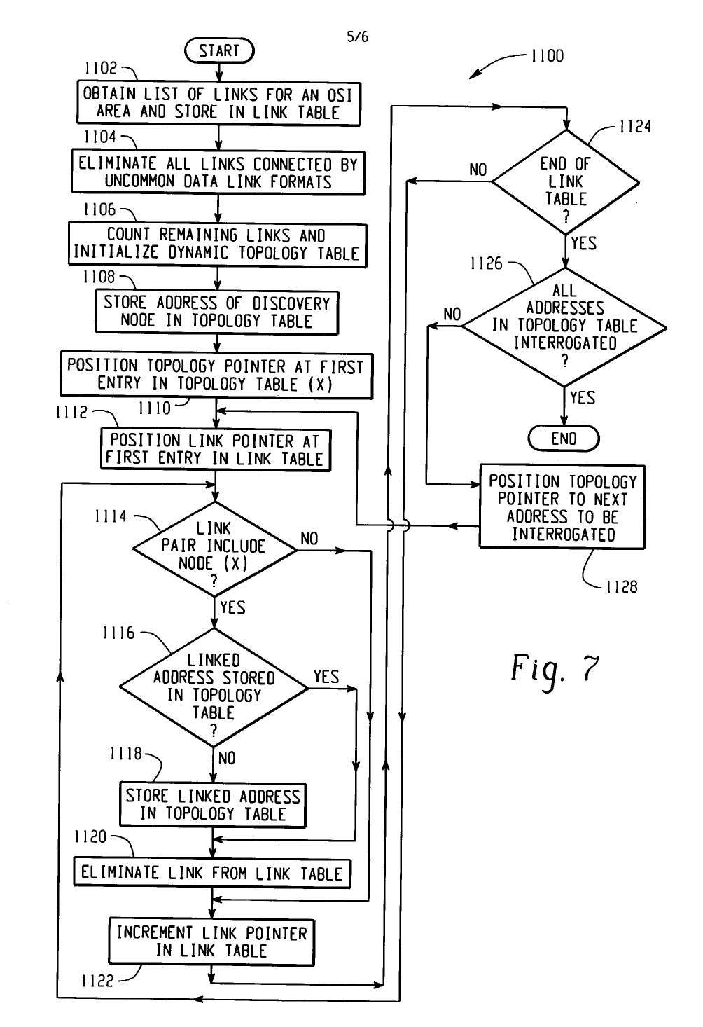

The topology module 110 does not provide a service on top of CLNP in a method similar to the IP encapsulation/decapsulation module 130 service, and does not require any additional support, such as a specific selector. FIG. 7 provides a flow diagram 1100 illustrating the process of network discovery during execution of a topology module 110 on the network element 20b.

In step 1102, the topology module obtains a list of links for an OSI area and stores the list in a link table 320. The list is illustratively obtained from the IS-IS Level 1 Link State Database. Thus, after execution of step 1102, the link table 320 is created, and includes the entries 321-336, as shown in FIG. 6. Each entry lists a link between network elements in the OSI area.

In step 1104, all links connected by uncommon data link formats are eliminated. Thus, in the link table 320, link entries 323 and 324 are eliminated, as network elements 20a and 20c are connected by the IP subnet 310. In another embodiment, links 323-330 are eliminated, as network elements 20c, 20d and 20e are in communication with the network element 20a via the IP subnet 310.

In step 1106, the topology table 340 is initialized. In one embodiment, the size of the topology table is equal to the number of links connected by a common data link format. Thus, because links 321, 322, and 331-336 are connected by a common data link format, the topology table 340 is initialized with eight cells. In another embodiment, topology table cells are added dynamically and as needed.

In step 1108, the address of the discovery node, which is network element 20b, is stored in the first entry 341 during the first iteration of the topology table 340.

In step 1110, a topology pointer is positioned at the first entry 341 of the topology table 340. The pointer represents a topology variable x, and because the pointer is pointing to the first entry of the topology table 341, the topology variable x represents the addresses of the network element 20b.

In step 1112, a link pointer is positioned at the first entry in the link table 320. The pointer is thus pointing to the link a-b stored in link entry 321, which represents the link between network elements 20a and 20b.

In step 1114, the topology module 110 determines if the link pair pointed to by the link pointer includes the node pointed to by the topology pointer. Thus, because the link a-b includes the addresses of network elements 20a and 20b, a positive determination results, and step 1116 is executed.

In step 1116, the topology module 110 determines if the other network element address in the link pair is currently stored in the topology table 340. Thus, because the address of the network element 20a is not stored in the topology table 340, a negative determination results, and step 1118 is executed.

In step 1118, the address of the other network element in the link pair is stored in the topology table 340. Thus, the address of network element 20a is stored in the topology table 340 at entry 342, as shown in the second iteration of the topology table 340.

In step 1120, the link pointed to by the link pointer is eliminated from the link table 320, and in step 1122, the link pointer is incremented in the link table 320. Thus, the link entry 321 is eliminated from further processing, and the link pointer is positioned at link entry 322.

In step 1122, the topology module determines whether the link pointer is at the end of the link table 320. Because the link pointer is only at the link entry 322, a negative determination results, and the topology module returns to step 1114.

Steps 1114-1124 are thereafter repeated. During this iteration, however, the topology table 340 will remain unchanged, as the link entry 322 will cause step 1116 to generate a positive determination, and the topology module 110 will skip to step 1120.

Upon reaching the end of the link table 320, the topology module 110 determines in step 1126 if all addresses of network elements 20 stored in the topology table 340 have been interrogated. Because the address of network element 20a has been added to the topology table 340, a negative determination results. Thus, the topology pointer is positioned to the topology entry 342 in step 1128, and the link pointer is positioned at the first available entry in the topology table 320 in step 1112. Steps 1114-1126 are thereafter repeated.

Following the flow diagram 1110 through the remaining execution yields the third and fourth iterations of the topology table 340. The fourth iteration of the topology table 340 shows the final form of the topology table 340. Topology table entries 341-344 store the address of network elements 20b, 20a, 20g and 20f, respectively. The network elements 20b, 20a, 20g and 20f are thus the network elements available for IP tunneling.

Once the addresses of the network elements 20b, 20a, 20g and 20f are stored in the topology table 340, the addresses are mapped to IP addresses.

If the network element 20 uses an IP stack that implements ARP, a regular ARP process is used. If the IP stack forwards the IP datagram with the Ethernet header, the MAC address in the latter is used. However, if the IP stack is not capable of adding the Ethernet header, a regular ARP mechanism can be used to extract the MAC address.

If the network element 20 uses an IP stack that does not implement ARP, a pseudo-ARP mechanism is used to map MAC addresses to NSAP addresses.

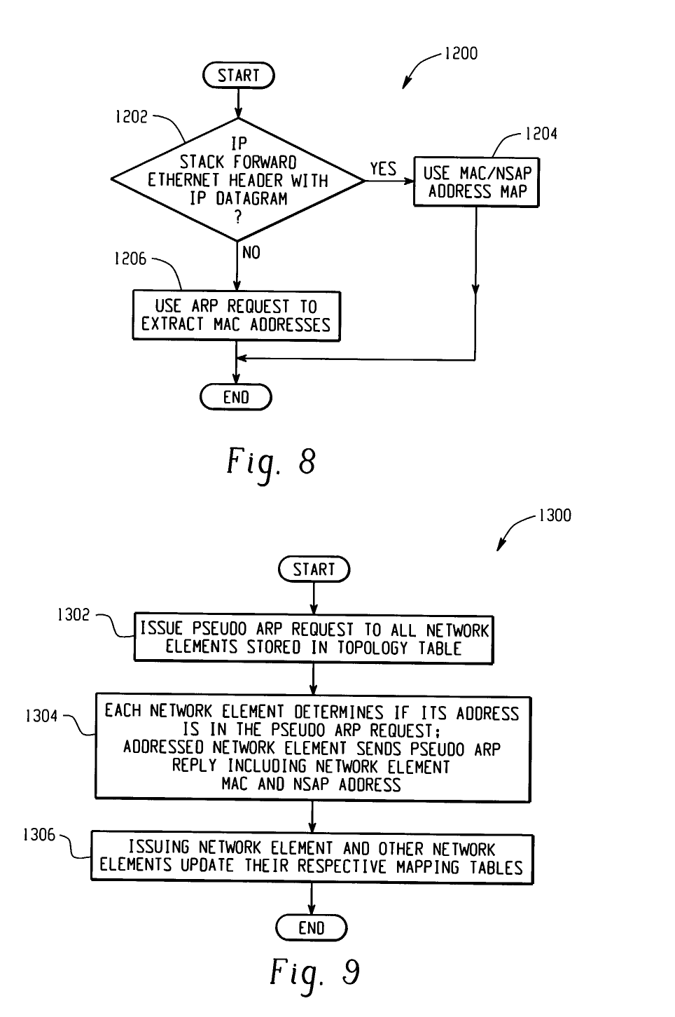

FIG. 8 provides a flow diagram 1200 illustrating the process of address resolution in a network element 20 having an IP stack that utilizes ARP. The flow diagram of FIG. 8 facilitates the mapping of MAC addresses to NSAP addresses. In step 1202, the mapping module 120 determines if the IP stack has forwarded the Ethernet header with the IP datagram. If the IP stack has forwarded the Ethernet header with the IP datagram, then in step 1204 the mapping module 120 uses a MAC/NSAP address map. If the IP stack has not forwarded the Ethernet header with the IP datagram, however, then in step 1206 the mapping module 120 uses an ARP request to extract the MAC address.

For a network element that does not have an IP stack that utilizes an ARP request, network MAC and NSAP addresses for the network element 20 are determined via a pseudo-ARP request. FIG. 9 provides a flow diagram 1300 illustrating a process of managing a pseudo-ARP request. If there is no entry in the routing table that associates the destination MAC address with a NSAP address, the pseudo-ARP request is issued and sent to all network elements 20 having addresses stored in the topology table 340, as shown in step 1302.

In step 1304, each network element determines if its address is in the pseudo-ARP request. If a network element determines that its address is in the request, the network element sends a pseudo-ARP response with its MAC address and NSAP address.

In step 1306, the issuing network element will update its mapping table. All other network elements that received the pseudo-ARP request and reply will also update their tables with the replying network element MAC and NSAP addresses.

If there is an entry in the routing table that associates the destination MAC address with a NSAP address, the pseudo-ARP process will update its internal timers (at the source and destination) and the datagram will be sent directly to the destination. For both cases mentioned above, the Ethernet header is analyzed to identify the scenario.

The actual broadcasts are based on the discovered topology stored in the topology table 340. Since this is a dynamic configuration, and a topology discovery can create significant traffic on the DCC, a minimum interval between each discovery can be set. In one embodiment, the minimum interval is set to 5 minutes for IP broadcast traffic, and 2 minutes for pseudo-ARP broadcasts. For example, if an IP broadcast is needed and 5 minutes have not elapsed from the previous topology discovery, the same topology table 340 will be used. A discovery will take place (i.e. updating the topology module 340) only if 5 minutes have elapsed from the previous discovery. The same holds for a pseudo-ARP broadcast, but with a time interval of 2 minutes.

The pseudo-ARP mechanism's selector value is configurable, and is set to 0x30 by default.

The embodiments described herein are examples of structures, systems or methods having elements corresponding to the elements of the invention recited in the claims. This written description may enable those of ordinary skill in the art to make and use embodiments having alternative elements that likewise correspond to the elements of the invention received in the claims. The intended scope of the invention thus includes other structures, systems or methods that do not differ from the literal language of the claims, and further includes other structures, systems or methods with insubstantial differences from the literal language of the claims.

What is claimed is:

1. A method of providing Internet Protocol (IP) tunneling over an Open System Interconnect (OSI) network system comprising a plurality of network elements, the method comprising the steps of:
determining a first network element topology of network elements eligible for IP tunneling for a first network element;
mapping the network elements eligible for IP tunneling to corresponding IP address;
encapsulating an IP datagram into an OSI frame;
transmitting the IP datagram over the OSI network; and
decapsulating the IP datagram from the OSI frame.

2. The method of claim 1, wherein the step of determining a first network element topology of network elements eligible for IP tunneling for a first network element comprises the steps of:
determining a list of first addresses corresponding to network elements in an OSI area; and
storing the addresses in a topology table.

3. The method of claim 2, wherein the step of determining a list of first addresses corresponding to network elements in an OSI area comprises the steps of:
interrogating an Intermediate System-to-Intermediate System (IS-IS) link table;
traversing the IS-IS link table to determine paths from the first network element to other network elements in the network system in direct communication with the first network element over the OSI channel; and
storing in a topology table the addresses of the network elements in the network system in direct communication with the first network element over the OSI channel.

4. The method of claim 3, wherein the OSI channel is a Data Communication Channel (DCC) in a Synchronous Optical Network (SONET) system.

5. The method of claim 3, wherein the network elements in the network system are in direct communication with the first network element over the OSI channel when the network elements are connected by a common data link format.

6. The method of claim 2, wherein the step of determining a list of first addresses corresponding to network elements in an OSI area relative to the first network element includes the step of eliminating from the list of first addresses addresses of network elements in communication with the first network element via an Ethernet network.

7. The method of claim 1, wherein the step of mapping the network elements eligible for IP tunneling to IP addresses comprises the steps of mapping IP addresses to Network Service Access Point (NSAP) addresses corresponding to the network elements eligible for IP tunneling.

8. The method of claim 1, wherein the step of mapping the network elements eligible for IP tunneling to corresponding IP addresses comprises the steps of mapping Media Access Control (MAC) addresses corresponding to the network elements to NSAP addresses corresponding to the network elements eligible for IP tunneling.

9. The method of claim 8, wherein the list of first addresses stored in the topology table are NSAP addresses, and further comprising the step of associating the list of first addresses stored in the topology table with corresponding MAC addresses.

10. The method of claim 9, wherein the step of mapping the network elements eligible for IP tunneling to corresponding IP addresses further comprises the steps of:
determining if a MAC address corresponds to one of the NSAP addresses stored in the topology table;
upon a negative determination:
transmitting an address resolution message to all network elements corresponding to the NSAP addresses stored in the topology table;
receiving a reply message indicating the NSAP address that corresponds to the MAC address; and
updating the topology table in response to the reply message received.

11. The method of claim 10, wherein the steps of determining a first network element topology of network elements eligible for IP tunneling for a first network element and mapping the network elements eligible for IP tunneling to corresponding IP address are performed at periodic intervals.

12. The method of claim 1, wherein the step of encapsulating an IP datagram into an OSI frame comprises the steps of inserting the IP datagram into an OSI frame.

13. The method of claim 12, wherein the OSI network system comprises a Synchronous Optical Network (SONET) network, and the step of inserting the IP datagram into an OSI frame comprises the steps of:
segmenting the IP datagram into one or more IP data packets; and
inserting the one or more data packets into the Transport Overhead (TOH) of a Synchronous Payload Envelope (SPE).

14. The method of claim 13, wherein the step of inserting the one or more IP data packets into the TOH of a SPE comprises the step of inserting the one or more IP data packets into a Data Communication Channel (DCC) of one or more SPEs.

15. The method of claim 14, wherein the step of decapsulating the IP datagram from the OSI frame comprises the steps of:
receiving the one or more SPEs;
extracting the one or more IP data packets from the DCC of the one or more SPEs; and
assembling the one or more data packets into the IP datagram.

16. A system for providing Internet Protocol (IP) tunneling over an Open System Interconnect (OSI) network system comprising a plurality of network elements, the system comprising:
a topology module executable on a first network element and operable to determine a first network element topology of network elements eligible for IP tunneling for the first network element;
a mapping module executable on the first network element and operable to map the network elements eligible for IP tunneling to corresponding IP addresses; and
and encapsulation/decapsulation module executable on the first network element and operable to encapsulate an IP datagram into an OSI frame and decapsulate the IP datagram from an OSI frame.

17. The system of claim 16, wherein the topology module is further operable to determine a list of first addresses corresponding to network elements in an OSI area relative to the first network element, and store the list of addresses in a topology table.

18. The system of claim 16, wherein the topology module is further operable to interrogate an Intermediate System-to-Intermediate System (IS-IS) link table, traverse the IS-IS link table to determine paths from the first network element to other network elements in the network system in direct communication with the first network element over an OSI channel, and store in a topology table the addresses of the network elements in the network system in direct communication with the first network element over the OSI channel.

19. The system of claim 17, wherein the topology module is further operable to eliminate from the list of first addresses addresses of network elements in communication with the first network element via an Ethernet network.

20. The system of claim 18, wherein the network elements in the network system are in direct communication with the first network element over the OSI channel when the network elements are connected by a common data link format.

21. The system of claim 16, wherein the mapping module is further operable to correspond network elements to IP addresses by mapping IP addresses to Network Service Access Point (NSAP) addresses corresponding to the network elements eligible for IP tunneling.

22. The system 16, wherein the mapping module is further operable to map Media Access Control (MAC) addresses to NSAP addresses corresponding to the network elements eligible for IP tunneling.

23. The system of claim 17, wherein the list of first addresses stored in the topology table are NSAP addresses, and the mapping module is further operable to associate the list of first addresses stored in the topology table with corresponding MAC addresses.

24. The system of claim 23, wherein the mapping module is further operable to determine if a MAC address corresponds to one of the NSAP addresses stored in the topology table, and upon a negative determination transmit an address resolution message to all network elements corresponding to the NSAP addresses stored in the topology table, receive a reply message indicating the NSAP address that corresponds to the MAC address, and update the topology table in response to the reply message received.

25. The system of claim 24, wherein the mapping module is further operable to receive an address resolution message from another network element, and determine whether a MAC address corresponds to the NSAP address corresponding to the first network element.

26. The system of claim 17, wherein the OSI network system comprises a Synchronous Optical Network (SONET) network, and the encapsulation/decapsulation module is operable to IP segment the IP datagram into one or more IP data packets and insert the one or more data packets into the Transport Overhead (TOH) of a Synchronous Payload Envelope (SPE).

27. The system of claim 26, wherein the encapsulation/decapsulation module is further operable to insert the one or more IP data packets into a Data Communication Channel (DCC) of one or more SPEs.

28. The system of claim 27, wherein the encapsulation/decapsulation module is further operable to receive the one or more SPEs, extract the one or more IP data packets from the DCC of the one or more SPEs, and assemble the one or more data packets into the IP datagram.

29. The system of claim 28, wherein the encapsulation/decapsulation module is implemented in a service on top of a Connectionless Network Protocol (CLNP).

30. A system for providing Internet Protocol (IP) tunneling over an Open System Interconnect (OSI) network system comprising a plurality of network elements, the system comprising:
means for determining a first network element topology of network elements eligible for IP tunneling for a first network element;
means for mapping the network elements eligible for IP tunneling to corresponding IP address; and
means for encapsulating an IP datagram into an OSI frame and decapsulating the IP datagram from the OSI frame.

31. The system of claim 30, wherein the means for determining a first network element topology of network elements eligible for IP tunneling for a first network element is adapted for determining a list of first addresses corresponding to network elements in an OSI area and storing the addresses in a topology table.

32. The system of claim 30, wherein the wherein the means for determining a first network element topology of network elements eligible for IP tunneling for a first network element is adapted for interrogating an Intermediate System-to-Intermediate System (IS-IS) link table; traversing the IS-IS link table to determine paths from the first network element to other network elements in the network system in direct communication with the first network element over the OSI channel; and storing in a topology table the addresses of the network elements in the network system in direct communication with the first network element over the OSI channel.

33. The system of claim 30, wherein the means for mapping the network elements eligible for IP tunneling to IP addresses is adapted for mapping IP addresses to Network Service Access Point (NSAP) addresses corresponding to the network elements eligible for IP tunneling.

34. The system of claim 30, wherein the means for mapping the network elements eligible for IP tunneling to IP addresses is adapted for mapping Media Access Control (MAC) addresses corresponding to the network elements to NSAP addresses corresponding to the network elements eligible for IP tunneling.

35. The system of claim 31, wherein the list of first addresses stored in the topology table comprise NSAP addresses, and further comprising means for associating the list of first addresses stored in the topology table with corresponding MAC addresses.

36. The system of claim 35, wherein the means for mapping the network elements eligible for IP tunneling to corresponding IP addresses is adapted for determining if a MAC address corresponds to one of the NSAP addresses stored in the topology table, and upon a negative determination transmitting an address resolution message to all network elements corresponding to the NSAP addresses stored in the topology table, receiving a reply message indicating the NSAP address that corresponds to the MAC address, updating the topology table in response to the reply message received.

37. The system of claim 30, wherein the means for encapsulating an IP datagram into an OSI frame and decapsulating the IP datagram from the OSI frame is adapted for segmenting the IP datagram into one or more IP data packets, inserting the one or more data packets into the Transport Overhead (TOH) of a Synchronous Payload Envelope (SPE) transmitted over a Synchronous Optical Network (SONET) system, extracting the one or more IP data packets from the DCC of the one or more SPEs, and assembling the one or more data packets into the IP datagram.
